(19) United States
(12) Patent Application Publication
(10) Pub. No.: US 2005/0178244 A1
(43) Pub. Date: Aug. 18, 2005

(54) Concrete anchor installation tool for use to install overhead a concrete drive anchor with or without pretied wires, from the floor, for suspension of tubing, suspended ceilings or other items

(76) Inventor: Shawn Carl Hodges, Graham, WA (US)

Correspondence Address: Mister Shawn Hodges, 6610 246th Street East, Graham, WA, 98338, US

(21) Appl. No.: 11/079,538

(22) Filed: Feb. 22, 2005

Related U.S. Application Data
(63) Continuation of application No. 10/341,757, filed on Jan. 14, 2003.

(51) Int. Cl. B25D 1/00

(52) U.S. Cl. 81/27

(57) ABSTRACT

An impact installer of concrete anchor drive pins into a predrilled hole by a slide hammer-type action with a consumable midsection of tubing that is to be replaced as needed for length or wear that is attached to the slide hammer assembly and the anchor adapter assembly that holds the concrete anchors so that the anchor drive pins may be inserted with an installer at floor level to a concrete ceiling above or other situations like a concrete wall where hammering the anchors in by hand is not feasible nor convenient. A slot in the adapter that holds the concrete drive pin will support an eyelet drive pin that has a pretied wire attached so the pretied wire is not damaged during installation.

### CROSS-REFERENCE TO RELATED APPLICATIONS UNITED STATES PATENTS

3,568,657 3/1971 Gue 81/27

4,423,721 01/1984 Otte et al. 81/27

6,125,719 10/2000 Lowther/Welden 81/27

6,226,948 05/2001 Trout 81/27

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

In construction it is common to climb a ladder, scaffold or other type of elevating device to install a post concrete drive anchor with an eyelet into a predrilled hole in an overhead concrete deck by striking the pin with a hammer to set said anchor and push a wire through the eyelet and tie the wire around itself to secure the wire at the drive anchor end and let the length of the wire hang down and be used to tie the suspended ceiling, heating and air duct or mechanical tubing or other item at a prescribed height.

In the past, in order to install pretied wire/concrete pins from the ground, a pipe long enough to make contact with a concrete deck overhead with an attachment on the top and a slide hammer on the bottom was used to install a wire/concrete drive anchor with eyelet combination by striking the slide hammer against a stop or a pole without a slide-hammer and striking the end of the pole with a hammer, transfering the energy to strike the drive anchor into a predrilled hole. The hole for the anchor would already have been drilled by attaching a roto hammer with bit to a pole (electrical mechanical tubing or similar pole) and having it predrilled before the pin was inserted. The pole was non adjustable for changing height conditions and was exceptionally heavy because the pipe would need to be thick to take the continued blows of the slide hammer and the heavy welding to make the pole. After any part would fail, the whole unit would then need to be rebuilt or junked.

Another failure was the design of the attachment which consisted of a 9/16″ deep impact socket that had a notch in it to clear the wire and also had the pin sit on slim shoulders inside the socket to drive the anchor into the hole, the common drive anchor, not being as wide as a 9/16″ nut opening would be loose in the 9/16th of an inch cavity since the drive anchor was smaller than the opening and it would be common to get stuck in the hollow center of the deep impact socket after many blows from the slide hammer because the shallow shoulders inside the socket would wear out rapidly.

Other inventors have created slide hammers with removable heads but they do not have the light weight nor a slide that stays on the pole when the pole is turned upside down. U.S. Pat. No. 6,349,618 to Lowther is a slide hammer that mainly relies on horizontal or downward motion with the slide hammer for bodywork on automobiles. The length of the pole is nearly static, and with the heavy weight of the unit, if it could be lengthened it would add to an already heavy slide hammer that would be difficult to operate all day to install wires if an attachment was made. It appears that if the slide hammer was turned upside down with the adapter end up that the plunger of the slide would fall out on Lowther's design.

Objects and advantages of the adjustable length, concrete anchor installation tool are several, they are:
(a) it is one object of this invention to provide a slide hammer with a consumable mid section and an adapter at the other end, with the consumable mid section to be a common item that can be cut to length to make the pole adjustable for length after appropriate fastening devices link the slide hammer, mid section and adapter together.
(b) it is another object to have a consumable mid section that is light weight compared to a heavier, more solid pipe, that may last longer but would wear out the user from the constant heavy weight.
(c) it is yet another object of this invention to provide a consumable mid section that will also wear out faster than the slide hammer and adapter pieces, lengthening the usable life of the slide hammer and adapter.
(d) it is yet another object of this invention to create an atmosphere where the consumable mid section will accordian at the bottom or top of the pole and the shape of the pole it is attached to will allow the mid section to be slid off and cut down and reused.
(e) it is yet another object of this invention for the adapter to hold the concrete pin with eyelet and a pretied wire steady in a prescribed stance for easy insertion into the predrilled hole.
(f) it is yet another object of this invention for the adapter to be built so the wire/concrete pin combination can be installed in the hole, and the tool removed without getting stuck on the concrete anchor as prior adapters after continued use.
(g) it is yet another object of this invention to be able, with a small consumable mid section, to be small enough to carry in the back of a truck, or even the trunk of a car, instead of the large and bulky size of the original one piece tools.

Further object and advantages are to provide a tool that can be used conveniently and effectively from the floor to install the concrete anchor-wire combination to be installed into a concrete overhead deck to eliminate the need or use of a ladder, scaffold or other personal height enhancing device with a comfortable working tool height by the ability to adjust the length of the pole, and then be able to take the tool apart in sections to store for the next application.

A secondary object and advantage of the floor use listed above is when the height is higher than can be reached from the floor a scaffold or other personal height enhancing device can be used in conjunction with the concrete anchor installation tool allowing the installer to stay closer to the ground than would be possible.

### DRAWING FIGURES

FIG. 1 is a side view of the overhead concrete installation tool assembled.

FIG. 2 is a partially exploded view of the main parts and assemblies.

FIG. 3 is a side view of the slide hammer assembly.

FIG. 4 is a fragmentary vertical section taken along line 4-4 of FIG. 3.

FIG. 5 is a fragmentary engineering view taken along line 5-5 of FIG. 4.

FIG. 6 is a vertical section taken along line 6-6 of FIG. 4.

FIG. 7 is an isometric view of the anchor adapter assembly.

FIG. 8 is a side view of the anchor adapter assembly.

FIG. 9 is an engineering view of the anchor adapter assembly.

FIG. 10 is a vertical section taken along line 10-10 of FIG. 8.

FIG. 11 is a vertical section taken along line 11-11 of FIG. 8 for an adapter application of anchor style FIG. 16, anchor supplied by others.

FIG. 12 is a vertical section taken along line 12-12 of FIG. 8.

FIG. 13 is an alternate of FIG. 11 for a lesser used pin for application of barrel pin style FIG. 18, pin supplied by others.

FIG. 14 is a vertical section taken along line 14-14 of FIG. 8.

FIG. 15 is a vertical section taken along line 15-15 from the top of FIG. 21 with an anchor-wire FIG. 20 assembly inserted for installation.

FIG. 16 is an isometric view of a standard type of concrete anchor with an eyelet.

FIG. 17 is a vertical section taken along line 15-15 from the top of FIG. 21 with an anchor-wire assembly similar to FIG. 20 but with barrel anchor FIG. 18.

FIG. 18 is an isometric view of a type of concrete anchor and eyelet.

FIG. 19 is an isometric view of anchor adapter assembly FIG. 7 with fragment of consumable mechanical tubing 26 inserted and pinned 28.

FIG. 20 is an anchor similar to FIG. 16 and a fragment of a pretied wire attached, both supplied by others.

FIG. 21 is an upper fragment isometric view of assembly FIG. 19 and assembly FIG. 20 combined, ready for installation.

FIG. 22 illustrates a view of an overhead concrete anchor tool with anchor-wire assembly ready for anchor installation.

FIG. 23 illustrates a view of FIG. 22 with anchor introduced to a predrilled hole for installation with slide hammer 30 moving toward impact ring 32.

FIG. 24 illustrates a view of anchor-wire assembly FIG. 20 seated from multiple impacts of slide hammer 30 against impact ring 32.

FIG. 25 illustrates a view of anchor-wire assembly FIG. 20 and anchor tool FIG. 1 disengaged after insertion and seating.

FIG. 26 illustrates anchor-wire assembly FIG. 20 installed into concrete.

### REFERENCE NUMERALS IN DRAWING

3. Slide Hammer Assembly
7. Anchor Adapter Assembly
26. Consumable item: Metal Tubing
28. Hardened pin with spring wire keeper
30. Slide hammer
32A. Base Impact Ring
32B. Slide Impact Ring
32C. Adapter Impact Ring
34A. Slide-Hammer Assembly Shaft
35B. Anchor Adapter Assembly Shaft
36. Tubing Receiver
38. Grip
40. Pin hole
42. Tang weld spot
44. Modified 9/16″, ⅝″ or applicable size deep impact socket
46. Anchor Support Shaft with Slot
48. Anchor slack eliminator dowels for type FIG. 16 pins
50. Wire Slot
52. Wire Relief
54. Nut Opening
56. Nut Stop
58. Pretied Wire

### DETAILED DESCRIPTION OF THE INVENTION

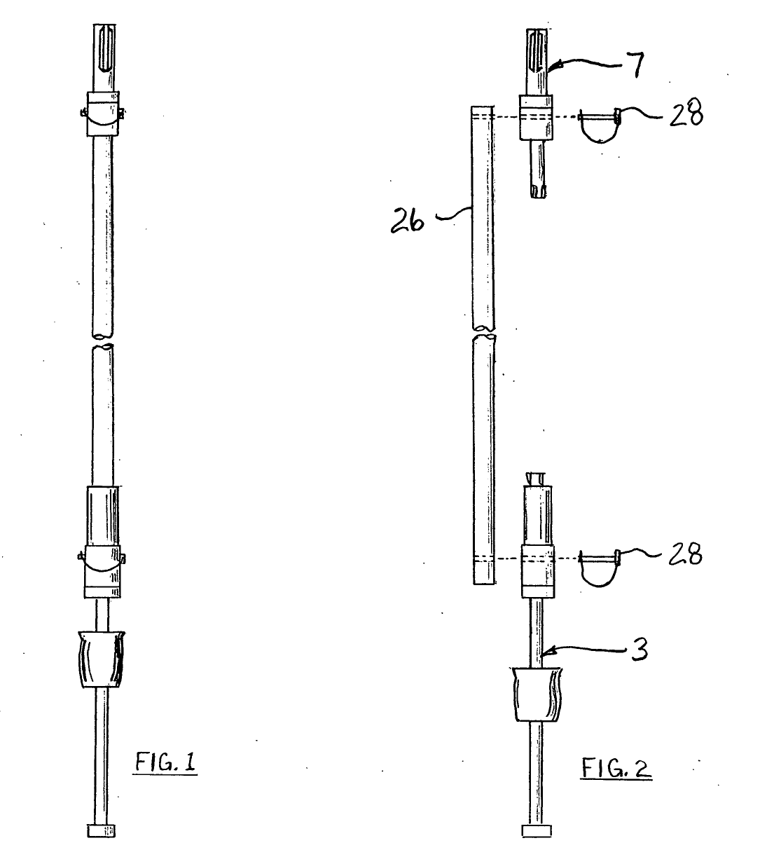

As shown in FIG. 2 there are five major components, an anchor adapter assembly 7, a slide hammer assembly 3, the thinwall electrical mechanical tubing 26 that is used to tie the two assemblies together, and there are two pins 28 that hold the concrete installation tool FIG. 1 together.

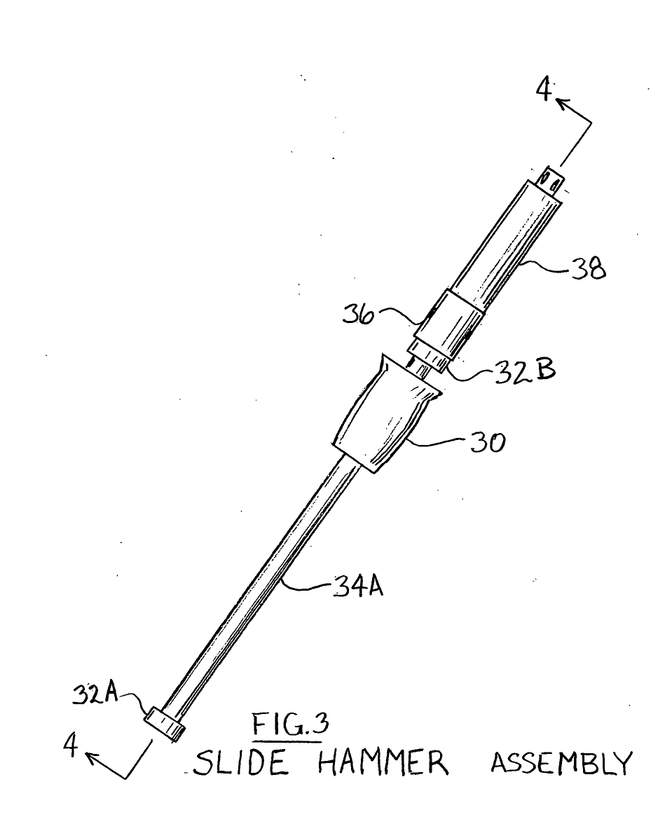

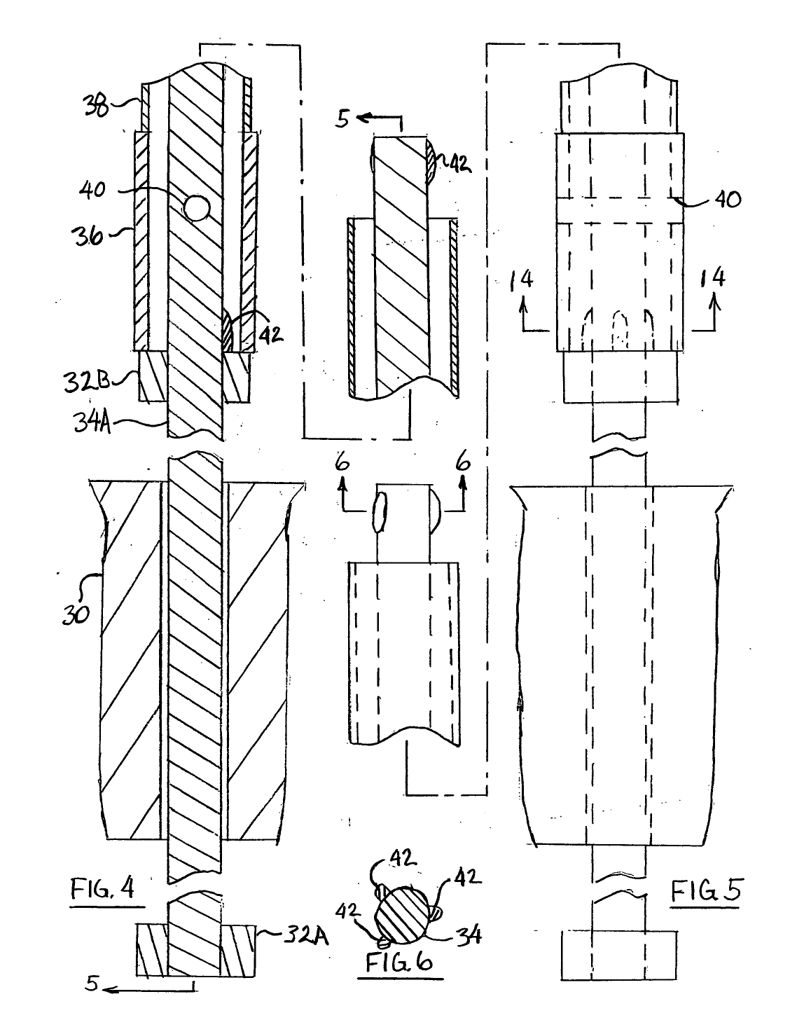

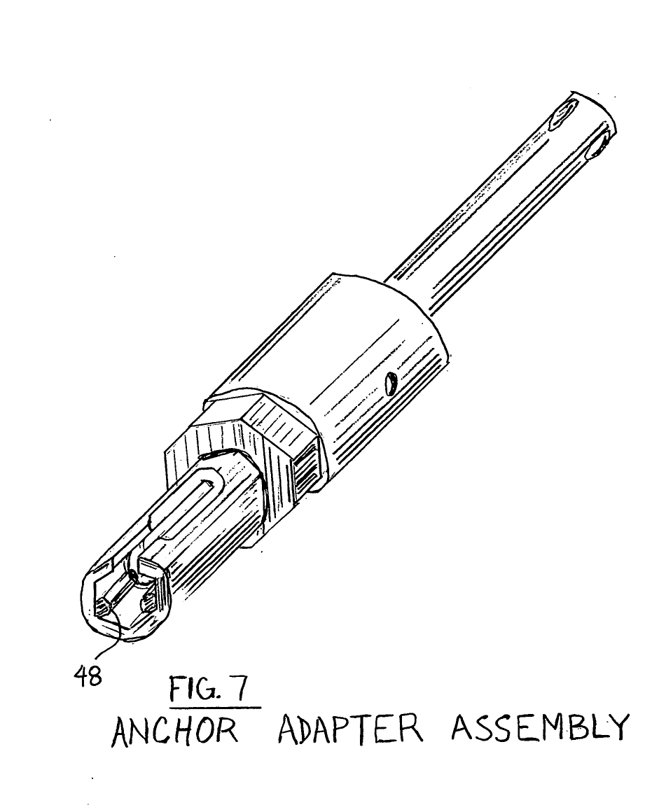

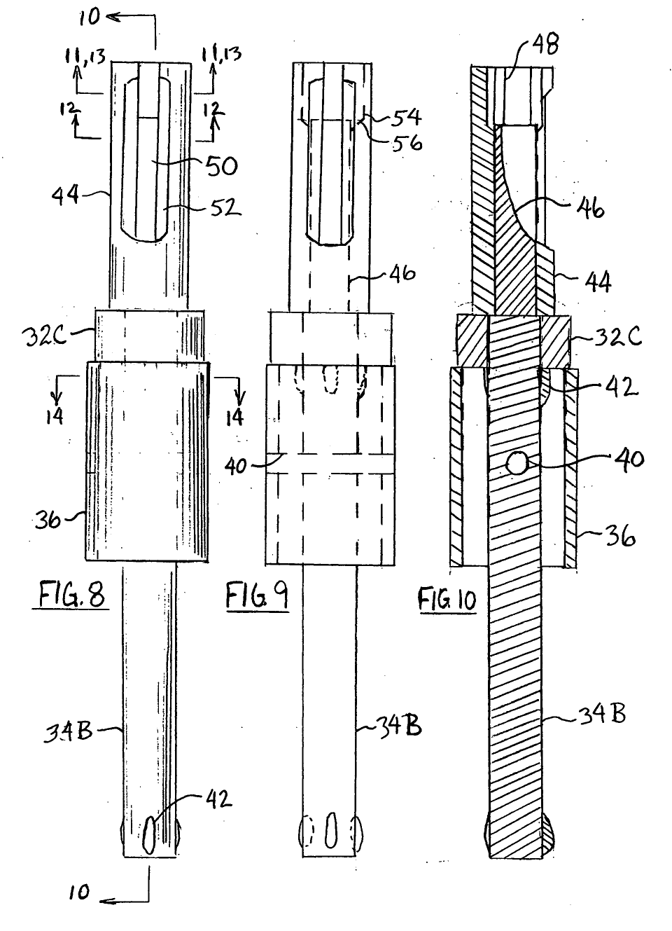

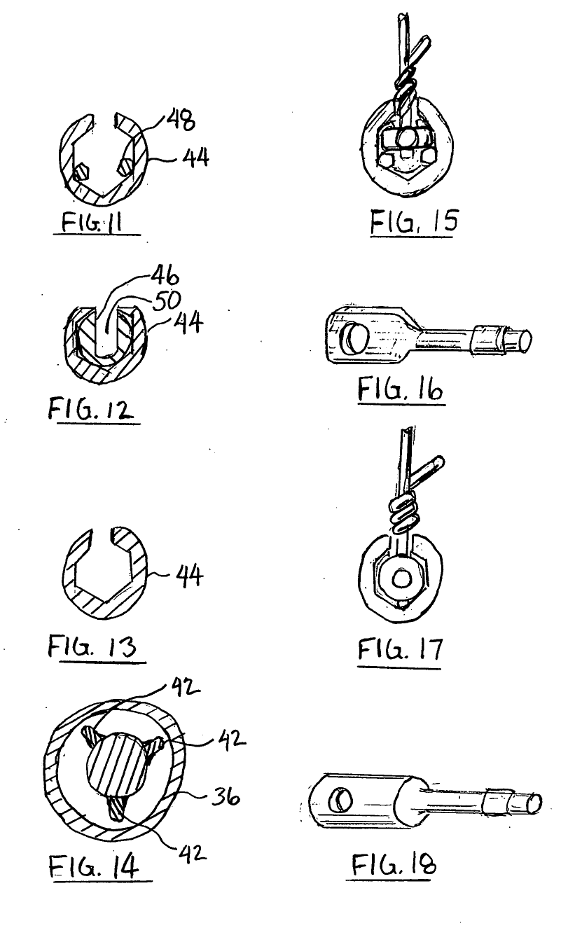

Anchor adapter assembly 7 and slide hammer assembly 3 are metal and both individual assembly's parts are to be welded to form a solid unit except for slide hammer 30 to the shaft 34 on the slide hammer assembly FIG. 3, which should move freely. Welds are not shown for clarity. The welds for impact rings 32 A,B,C need to be ground flat, parallel to the impact areas and tubing 26 seating areas so as to have full contact of slide hammer 30 flat impact area and to have a solid flat seating for the tubing 26. Impact rings 32 A,B should be of a hardened material that will take the impacts of the slide hammer 30 to prolong the use of the tool. Tubing receiver 36 which is large enough to allow tubing 26 to slide inside of it and shaft 34 which is small enough to allow tubing 26 to slide over it, has tang weld spots 42 that are built up as shown if FIG. 6 and FIG. 14 to allow shaft 34 to fit firm inside tubing 26. Tang weld spots 42 that are inside receiver 36 that are on the tang end of shafts 34 A,B should have their maximum width of slack elimination at the contact area of impact rings 32 B,C so when consumable tubing 26 begins to accordion inside receiver 36 after prolonged use it will not be able to pinch underneath weld spots 42 on the shafts 34 A,B therefore allowing removal of tubing 26 for replacement or repair. Tubing receiver 36 is of rigid pipe like size and on the slide hammer assembly FIG. 3 grip 38 could be made out of one piece (not shown) with receiver 36 but is preferred to have grip 38 to be of a thinwall type tubing to eliminate weight. Hole 40 is for pin 28, and tube 26 holes 40 are to be drilled when the base of tube 26 is sitting on impact rings 32 B,C.

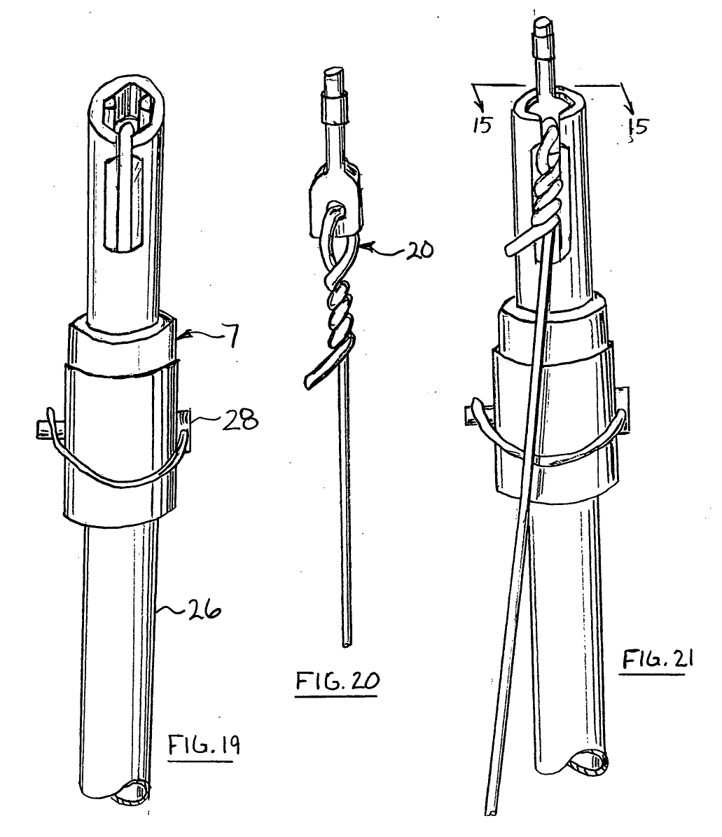

Wire slot 50 that is to be cut into deep 9/16″, ⅝″ or applicable size deep impact socket 44 is to be near ¼″ to 5/16″ in width to allow the tied wire of FIG. 20 to slide out easily. Wire relief 52 and slot 50 can be extended toward impact ring 32 until the peak of the slot 50 comes in contact with impact ring 32. Wire relief 52 is to be ground into the side of deep socket 44 at slot 50 at a depth that does not make the thickness of the socket less than 1/16″. The idea is to allow the wire to hang as natural as possible while it is being installed FIGS. 22-25. Anchor support shaft with slot 46 should be of a hardened steel and flushes out at the bottom of deep socket 44 and at the nut stop 56 of the socket nut opening 54. Anchor slack eliminator dowels 48 for FIG. 16 type anchors are to be welded in the corners as shown in FIG. 11 so anchor assembly FIG. 20 fits as shown.

The length of the tool FIG. 1 is determined by the length of the tubing 26 that will be cut on site to be a length most comfortable to the installer. To determine the most common proper length the tubing 26, a consumable item that will need to be replaced periodically as it is worn or when changes in length of the tool is needed, shall be a length that will allow the grip 38 to be held at chest level when the installation tool is in contact with the area to be anchored FIG. 24. Installation length will vary as installers have different comfort levels for length and position of the tool.

Anchors FIG. 16 and FIG. 18 may be installed without a wire pretied but the most common use will be an anchor-wire assembly FIG. 20. Using anchor-wire assembly FIG. 20 as an example application, install the anchor-wire assembly FIG. 20 in the opening of the socket FIG. 15 and FIG. 21 and seat it on the anchor support shaft 46 with the pretied wire FIG. 20 extending through the slot 50, FIG. 15, FIG. 17 and FIG. 21-24.

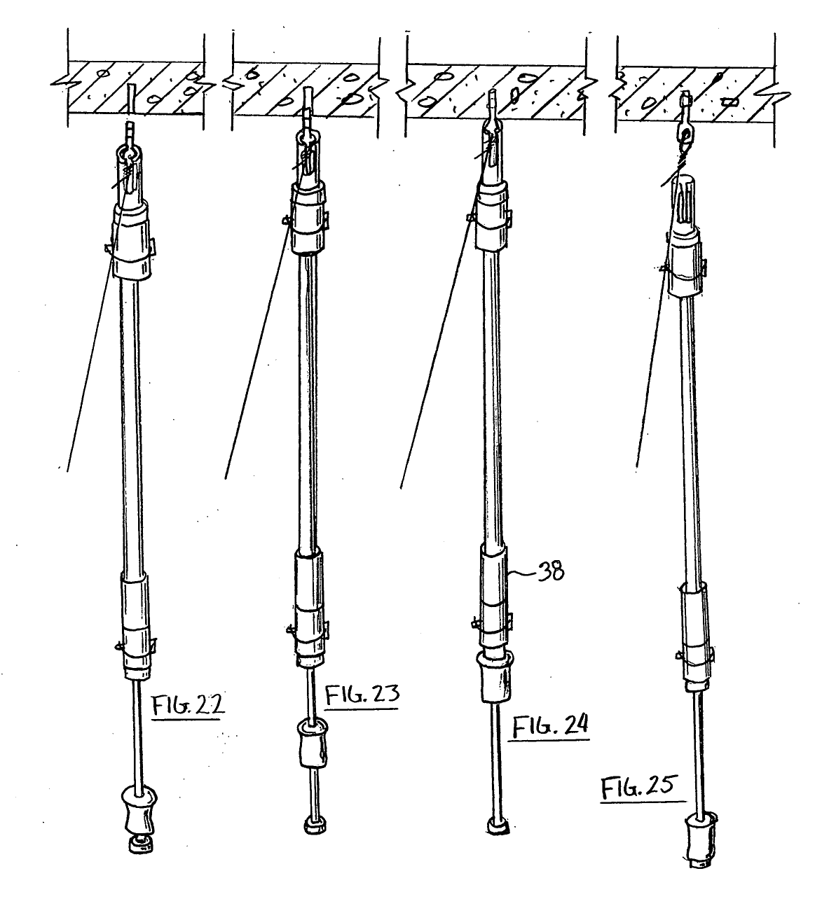

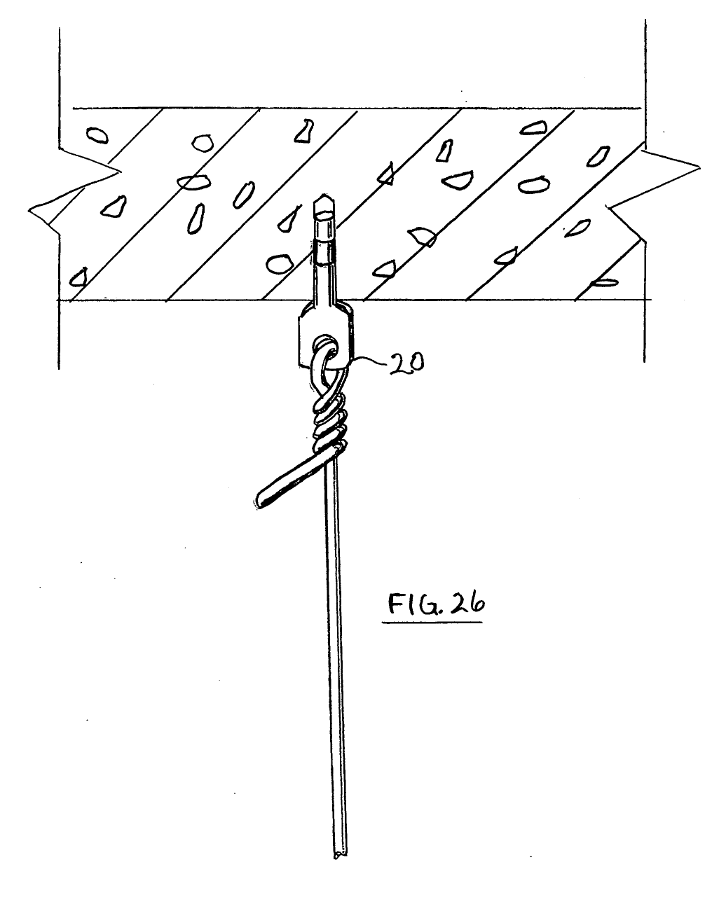

Holding the installation tool FIG. 22 towards the correctly sized predrilled hole introduce the anchor to the hole FIG. 23. With one hand, hold grip 38 near chest and the other hand on slide 30 at the bottom of shaft 34, move slide 30 toward impact ring 32 that is near pin 28 with force as needed until anchor FIG. 16 is seated FIG. 24. Pull Installation tool away FIG. 25 leaving installed anchor-wire assembly FIG. 26.

Most slide hammer assemblies have been used in the past for the automotive industry as a tool to pull or push dents out or to pull bearings out of mechanical devices and most concrete anchors are installed with either a hammer or another device that is near the anchor requiring a ladder, scaffold or other height enabling device. The concrete anchor installation tool FIG. 1 is to install anchors FIG. 16, and similar types of anchors, when the distance is more than an arms reach away.

Although the description above contains many specificities, these should not be construed as limiting the scope of the invention but as merely providing illustrations of some of the presently preferred embodiments of this invention. For example, the shafts could be made out of a thick tubing eliminating some weight and all parts hardened, or the tool itself could be used to install an anchor to the side of a concrete wall, not necessarily only a overhead deck.

1. A concrete anchor installation tool comprising:
a slide hammer-type elongated shaft assembly, anchor adapter assembly for the insertion of concrete anchors and consumable tubing, with or without ceiling wires pretied to an anchor;
A. slide hammer assembly:
1. a pair of longitudinally spaced, enlarged abutment members on one end of the elongated shaft integral with a hollow hammer that slides between the two abutment members for impact; and
2. a tubing receiver on the other end of said elongated shaft to receive a consumable tubing to connect with the anchor adapter assembly, the tubing receiver comprising:
a. tangs mounted at the base and at the distal end on the elongated shaft at the consumable tubing receiving area
b. hole through tubing receiver and elongated shaft to hold consumable tubing, consumable tubing to be held by a pin through consumable tubing and slide hammer assembly, and;
c. grip above the tubing receiver, and;
B. anchor adapter assembly:
1. a modified deep socket or like item to hold a concrete anchor with or without a pretied wire, with an elongated shaft attached at bottom of said modified socket, and;
2. a tubing receiver on the bottom end of modified deep socket so as to receive a consumable tubing to connect with the slide hammer assembly, the tubing receiver comprising:
a. tangs mounted at the base and at the distal end on the elongated shaft at the consumable tubing receiving area, and;
b. a hole through tubing receiver and elongated shaft to hold consumable tubing, consumable tubing held by a pin through consumable tubing and anchor adapter assembly, and;
C. Consumable tubing, to be cut to desired length by installer.

2. A concrete anchor installation tool comprising:
The tool claim of 1 including the combining of a single casting of the slide hammer assembly or a sum of the parts thereof with the exception of the slide hammer and abutment on one end; and a single casting of the anchor adaptor assembly or a sum of the parts thereof.

3. A concrete anchor installation tool comprising:
The tool claim of 1 including a substitution of hardened tubing for the consumable tubing.
